(19) United States
(12) Patent Application Publication
(10) Pub. No.: US 2010/0252429 A1
(43) Pub. Date: Oct. 7, 2010

(54) ION-SELECTIVE ELECTRODE

(76) Inventor: K. Jagan Rao, Moorestown, NJ (US)

Correspondence Address: DONALD C. SIMPSON, 126 BORTON LANDING ROAD, MOORESTOWN, NJ, 06057-3056, US

(21) Appl. No.: 12/754,807

(22) Filed: Apr. 6, 2010

Related U.S. Application Data
(60) Provisional application No. 61/167,489, filed on Apr. 7, 2009.

(51) Int. Cl. G01N 27/26

(52) U.S. Cl. 204/403.01

(57) ABSTRACT

A five-part electrode device, including a membrane formed in situ, which is useful in automated clinical chemistry analyzers, and the method of forming a direct solid state connection to the membrane eliminating the need for the use of an internal reference electrode requiring internal filling solutions.

### RELATED APPLICATIONS

Provisional Patent Application No. 61/167,489, the benefit of which is claimed herewith.

### FEDERALLY SPONSORED RESEARCH AND/OR DEVELOPMENT

None

This invention relates to electrochemical analytical device and particularly to a new and improved ion-selective electrode structure used in the determination of ion(activities) concentrations, and methods for making such structures.

### BACKGROUND OF THE INVENTION

Ion-selective electrodes are used in clinical chemistry to measure concentration(activity) of ions (like sodium, potassium, chloride and calcium) in blood, serum, plasma, cerebrospinal fluid, urine, fertilizers, and industrial fluids. These devices are used in automated and semi-automated instruments for direct measurements (undiluted samples) or indirect measurements (diluted samples).

Rao, et al, in U.S. Pat. No. 5,013,421 described a flow through type ion-selective lectrode device which uses a micro-porous tubular material impregnated with a matrix of an organic plastic material containing a nonvolatile solvent plasticizer and an ion-active material dissolved in the plasticizer, the plasticizer not being solvent for the tubular material. An electrode assembly was disclosed which involved a membrane material in which the membrane material communicates electrically directly through a metal conductor. The disclosure of that patent is incorporated herein by reference. The electrode described in the above-identified patent gives stable potentials, gives extended linear range and performs well in measuring the desired ionic species in the samples. However, the material used for the micro-porous tube has very limited number of manufacturers and is quite expensive. In addition, the manufacturing of the electrodes includes several steps spread over a number of days and there is no known way to speed up the process. A lot of skilled manual labor was needed to make these electrodes. Further, before final assembly, the electrodes need about 90 days of curing at room temperature for good slopes, drift free operation and good usage life. This electrode required nine different custom-made parts which contributed to large inventory and cost problems. The finished electrode has fairly large internal volume so it was not suitable for direct (undiluted) sample measurements. All these add to the cost of the product.

### SUMMARY OF THE INVENTION

The present invention comprises a five-part electrode device, counting the membrane formed in situ, which provides substantial improvements over the above noted invention and yet retains all the desirable characteristics and improved performance needed for the device's use in automated clinical chemistry analyzers. It also provides a direct solid state connection to the membrane eliminating the need for the use of internal reference electrode with internal filling solutions. This flow-through electrode can be made in half a day while actually occupying only a few minutes of the manufacturer's time in the conduct of the manufacturing steps. This device uses substantially less active reagent than the older device there by minimizing the use of costly ion-selective reagents and contributing to less expensive product. The manufacturing process for the new device is suitable for semi-automatic operation there by contributing to further reduction of manufacturing costs and providing increased productivity. The new invention electrodes cure in substantially less time (about 15 to 20 days) compared to 90 days for the older electrodes. Thus there is no longer a need to make electrodes ninety or more days in advance; they can be made about 18 or so days before they are needed. This allows for reduced inventory and reduced overhead costs for the product. The new device “exposes” only a small portion of the membrane to the flow path compared to the full length of the membrane in the older design electrodes. Since a smaller portion is exposed compared to the total length of the membrane tube, this device gives substantially longer usage life of the electrode than the older design electrodes. Since it is a solid state electrode without any internal filling solutions, it gives more than two years of shelf life. This is very important for the distributor and the customer.

### DESCRIPTION OF THE DRAWINGS

FIG. 1 is a partially exploded view of the novel electrode assembly comprising an electrode body, FIG. (1a), a silver wire electrode, FIG. 1(d), an electrode back cover with the silver wire electrode clipped into place, FIG. 1(c), and the electrode front cover, FIG. (b).

FIGS. 2(a) and 2(b) are two separate views of the electrode body according to the invention.

FIGS. 3(a), 3(b) and 3(c) are three separate views of the electrode front cover. FIG. 4 is a top view of the electrode cavity of FIGS. 2(a) and 2(b) showing the details of the electrode-receiving cavity in the electrode body.

FIG. 5 is a partial cross-section view of the final electrode assembly.

### DETAILED DESCRIPTION OF THE INVENTION

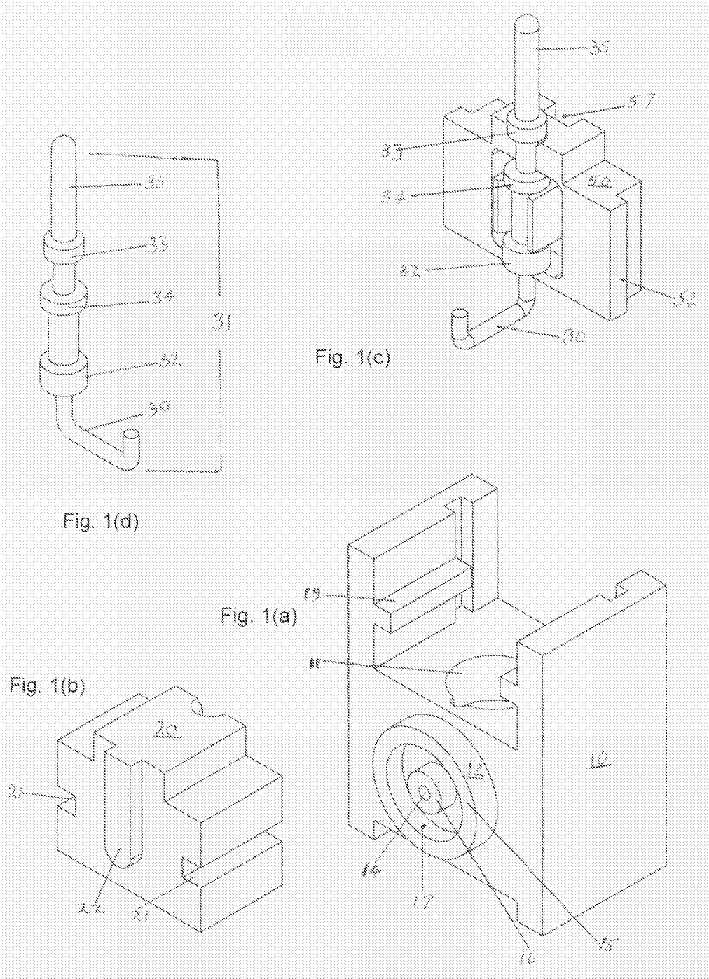

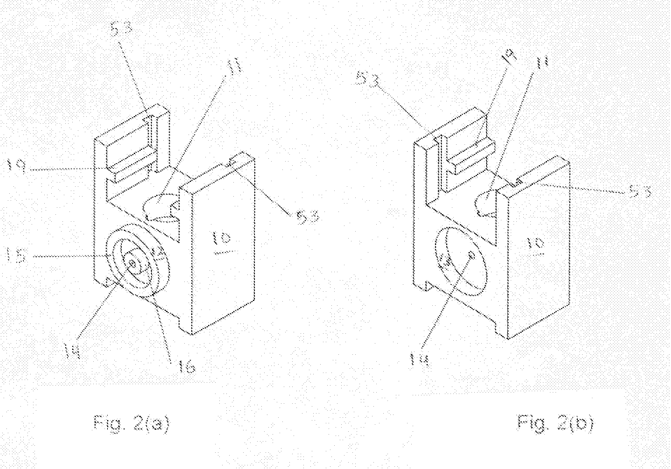

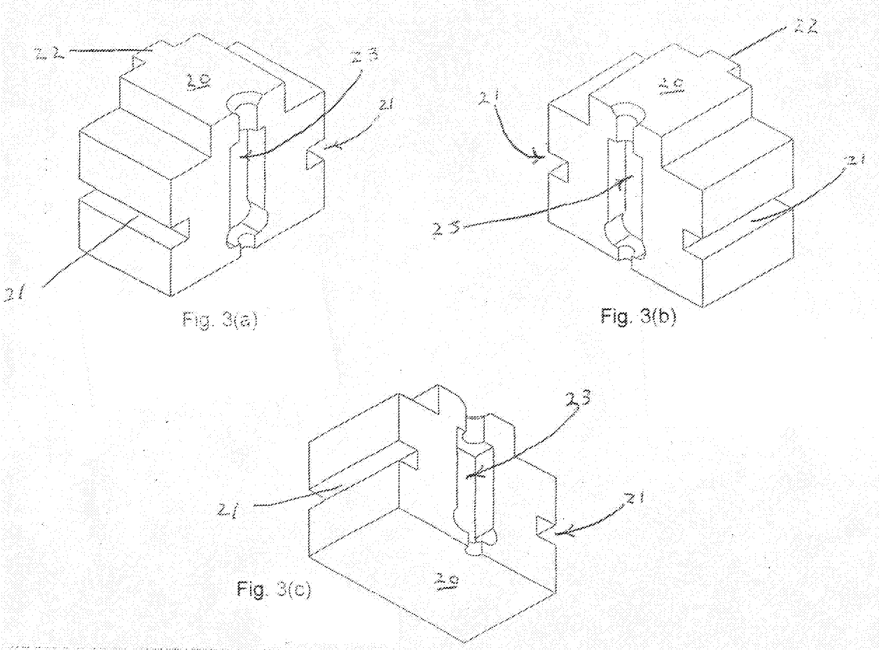

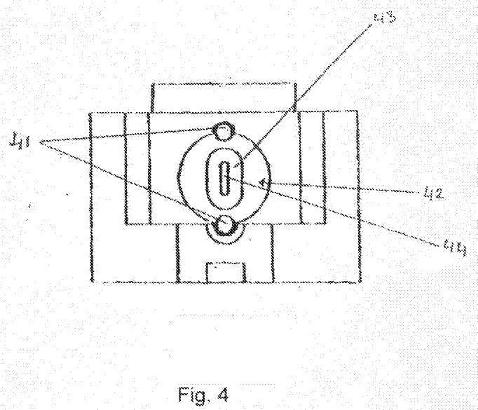

The present invention embodies a linear flow-through electrode of the present invention. As shown in the accompanying drawings, the electrode comprises an electrode body (10), an electrode front cover (20), electrode back cover (50) and a silver wire internal reference electrode (30) having an electrical connector (31) to connect the electrode to a measuring instrument. The connector typically has a crimping ring (32) for attaching the connector to the silver wire electrode (30), and spacer bushings (33) and (34) for spacing and holding the silver wire electrode and connector assembly in the final flow-through electrode assembly. In FIG. 1, wire 35 will connect directly to the measuring instrument.

The electrode body has a deep cavity (11) and has one male (12) and one female (13) bushing on either side of the flow path (14) through the body of the electrode. The male bushing (12) has a deep groove (17) between the outer (15) and the inner (16) circles of the bushing. An “O” ring can be installed into this groove and this “O” ring provides a leak free connection of the electrode with the female (13) bushing of the next electrode or to the waste outlet, as the case may be.

The electrode front cover (20) has an indentation (21) in it. This slips onto part (19) of the electrode body and provides a tight fit of the front cover to the electrode body. This cover is glued to the electrode body with a proper adhesive.

The electrode back cover (50) has an indentation (57) on the back side top of the body. When using multiple, ganged electrodes, this indentation can receive the part (22) of another electrode front cover (20) and assures proper alignment of the electrodes on the system. This is important for a smooth linear flow through the electrodes.

FIG. 4 shows the details of the cavity (11) in the electrode body (10) viewed from the top. The drawing shows a lager upper cavity (42), the smaller lower cavity (43) and the opening (44) to the top of the flow path in the electrode body (10). The silver internal reference electrode fits into the two grooves (41) on opposite ends of the larger cavity.

The silver wire electrode (30) is installed in the upper larger cavity (11) of the electrode body (10). The silver wire fits firmly into the “grooves” (41) in the electrode upper cavity and the electrode connector (31) fits firmly into the back cover “clip” (51). When the electrode body (10) and the back electrode cover (50), and the front electrode cover (20) are assembled to each other, indentations (23) and “clip” (51) match up to define a space in which the electrode-connector combination is held in operating position. A mandrel having an O.D. slightly less than the I.D. of the electrode flow path is inserted into the flow path (14) of the electrode body. The mandrel prevents the active reagent of the electrode from leaking out when the electrode cavity is filled with the reagent.

The electrode body has two cavities 42 and 43 (one below the other) as shown in FIG. 4. The silver wire with the electrode connector is installed in the top larger cavity of the body. The depth of the smaller cavity and the distance from the top of the cavity to the bottom of the silver wire controls the thickness of the ion-selective electrode membrane. The thickness of the membrane can be varied by varying the depth of the smaller cavity and varying the length of the silver wire attached to the electrode connector. The smaller tapered bottom cavity 43 connects to the top of the flow path through a small opening 44 in the bottom of the cavity as shown in FIG. 4. The size of the opening controls the exposure of the membrane to the sample flowing through flow path of the electrode.

The electrode back cover 50 has two projections (52) on both sides of the back of the cover. A thin layer of proper adhesive is applied to these two projections and the cover is slid down in two indentations (53) of the electrode body. This keeps the electrode back cover glued in place to receive the silver wire with the connector. After inserting a mandrel into the flow path of the electrode body, the electrode cavity is filled with an appropriate ion-selective electrode active reagent mixture. One such mixture comprises of a polymer such as polyvinylchloride (PVC) (Scientific Polymer Products) in Tetrahydrofuran (THF) (Alfa Aesar) solvent to which has been added an active ingredient such as Valinomycin (Sigma Scientific) together with a plasticizer such as Di-(2 EthylHexyl) Sebacate (Scientific Polymer Products) which is a solvent for the active ingredient. The method of making the ion-selective electrode active reagent mixture comprises the steps of dissolving an organic plastic material (e.g., PVC) in the volatile solvent (e.g., THF) and then mixing the non-volatile plasticizer and an ion exchange material (in the case of potassium it is a neutral carrier complex Valinomycin), which is soluble in the plasticizer, with the plastic material and the volatile solvent. The reagent flows in to the lower tapered small cavity of the electrode and fills it. Enough reagent mixture is added to the cavity 11 to completely fill the smaller cavity and fill half of the larger cavity. After the first filling the electrode is allowed to “cure” for about an hour at room temperature. During this time, most of the Tetrahydrofuran solvent evaporates away and the membrane shrinks considerably into the cavity. After about one hour curing, the cavity is again filled with a few drops of the reagent mixture and allowed to cure again. Once the cured membrane completely covers the smaller tapered inner cavity to the top (this could take one or two fillings), the silver wire with the connector is then inserted into electrode cavity and snapped into place into clip 51 of the electrode back cover. After installing the silver wire, the electrode cavity is filled to the top with the reagent mixture. Again it is allowed to cure for about an hour and filled again. This procedure of filling the cavity is repeated about three to five times (depending up on the type of electrode). After the final fill the electrodes are allowed to cure at room temperature for about 15 days.

After about 15 days of curing, the total membrane (56) shrinks in the cavity and gives a firm membrane (56). After the curing process is completed, the mandrel is pulled out. The mandrel comes out smoothly and formation of the membrane in the opening above the flow path at the bottom of the smaller tapered cavity could clearly be seen. The membrane formed in the two cavities covers the silver wire and the silver wire acts as the internal reference electrode there by providing solid-state connection to the electrode membrane. This avoids the use of clumsy silver/silver chloride internal reference electrode with associated aqueous liquid filling solutions or gels. The front electrode cover is then installed to cover the electrode cavity and hold the electrode connector attached to the silver wire firmly in place.

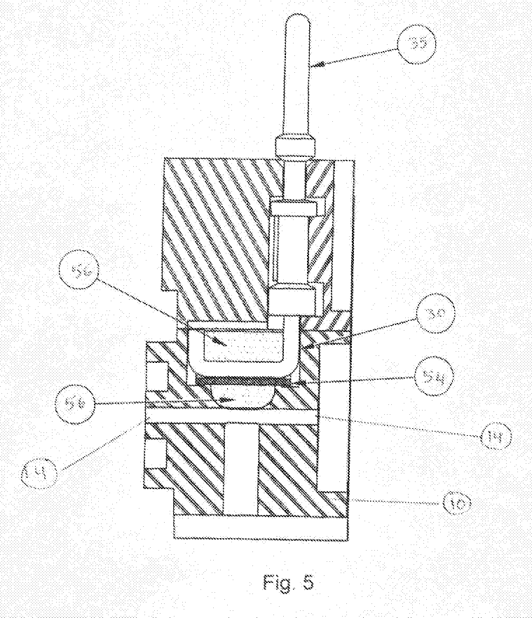

In general, membranes made for the solid-state electrodes are soft and some electrode reagent formulations have a tendency to trap air bubbles within the membrane matrix. Air bubbles, if present in the membrane could contribute to membrane failure by creating a shorting path between the sample and the internal reference electrode. This is not desirable. For such electrode formulations one way of overcoming the problem is by inserting a “conductive barrier” between the sample flow-path and the internal electrode which would allow ionic mobility within the membrane but prevent the shorting path between the internal reference electrode and the sample. This type of barrier membrane (54) is shown in FIG. 5.

The “barrier membrane” (54) shown in FIG. 5 helps to give some “rigidity” to the electrode membrane structure (which is generally soft) and also helps in preventing the micro air bubbles (if any formed during curing) from shorting the membrane. The barrier membrane can be a thin filter paper type material cut into round disk. With this electrode design, a disk of membrane cut with a paper-hole puncher fits perfectly well into the electrode cavity hole. The disk is first soaked or impregnated with the active reagent mixture and then installed into electrode cavity above the inner cavity. Once cured, the disk becomes an integral part of the total membrane. The silver wire with the connector is above the “barrier membrane”. The silver wire could be in contact or slightly above the “barrier membrane” as the case may be. The requirement for the barrier membrane material is that it is thin (like regular paper), is not soluble or reacts with any of the solvents, plasticizers or active ingredients used in making the membranes. It should also hold its shape when the membrane is cured. Some of the materials which could be used are:
(a) Micro porous pipe thread sealant tape made with polytetrafluoroethylene (PTFE). This tape is available in both commercial and premium grades. Thickness is typically around 0.0028 to 0.0032″ depending up on the grade. Premium grade is thicker than the commercial grade tape. These tapes soak in the active reagent well;
(b) Thin PTFE membranes with pore sizes which allow the impregnation of ion-selective reagent (typical pore size 5 to 50 microns) can be used;
(c) Cellulose acetate filter membranes which can soak in the active reagent (typical pore sizes 5 to 25 micrometers) can be used;
(d) Nylon mesh cloth (like women's stocking) can be used; and
(e) Thin porous ceramic or plastic frits could be used.

These are just a few examples of the materials that could be used as the barrier membrane. The material micro-pore size could be varied over a wide range. The major requirements are the forming of a barrier below the silver wire internal reference electrode and preventing the shorting of the internal reference electrode by any accidental micro-bubbles trapped in the membrane during its manufacture.

The electrode design of present invention is applicable to all types of ion-selective electrodes which are generally made with PVC membranes. This approach can also be used with other types of polymers like, poly urethane, carboxylated PVC, silicone rubber based membranes, just to mention a few. The technology can be used to make electrodes for potassium, a mono-valent cation and for carbonate, a divalent anion, as well as for calcium, chloride, lithium, magnesium, and similar ions. Novelty is not claimed in the choice of specific matrix materials used for the membrane described herein, but is directed primarily to the structures involving direct electrode contact with the membrane material. The preferred embodiment is without the barrier membrane, but in cases where the membrane has a tendency to trap air bubbles and/or needs some structural support, the embodiment with barrier membrane could be used for all of the reasons discussed previously herein to provide maximum efficiency of operation. Other embodiments of this invention will occur to those skilled in the art when viewing the disclosure and appended drawings.

### EXAMPLES

A potassium electrode and a chloride electrode (made with chloride active reagent) made according to the procedure described above were set-up for a life test performance study. The testing was done using a prototype direct sampling Ion-selective electrode instrument. The potassium and chloride electrodes were calibrated using the low and high calibrators and after successful calibration, a batch of 22 pooled human sera samples was run and the % C.V. (Coefficient of Variation) was noted for the run. After running a total of four 22 sample human sera runs, the system was re-calibrated and the process of running 22 cups of pooled human sera four times was repeated. At the end of the day, the electrodes were cleaned with an enzymatic cleaner and conditioned with conditioning solution. All the data was printed and saved. The testing was done for three months. Some days, less than 88 samples were run. During this testing period a total of 3512 pooled human sera samples were run. For both potassium and chloride electrode samples the % C.V. was less than 1 for each of the runs. A majority of the runs showed % C.V. of around 0.5 or better. The slope of potassium electrode at the start of the run was 59.78 mV (millivolts) and the chloride electrode slope was −45.18 mV. After running 3512 human sera samples, the potassium electrode slope was 58.5 mV and the chloride electrode slope was −44.16 mV. In both cases, there was practically no change in slope after running 3512 pooled human sera samples. At the end of the testing series, the potassium and chloride electrodes were removed from the instrument and stored in their respective original packages at room temperature.

More than a year from the start of the original testing, the potassium and chloride electrodes were re-installed on the ISE instrument and testing re-started Similar protocol of calibration, pooled human sera sample run and cleaning and conditioning of the electrodes were followed. This time only 4 runs of 22 pooled human sera samples were run each day. Once again the potassium and chloride electrode runs met the specification of less than 1% C.V. and the data were similar to the first run data. A total of 506 human sera samples were run during this period. This gave a combined total of 4018 samples. The slope of potassium electrode at restart of testing was 58.85 mV as compared to 59.85 mV at the original fresh start. The slope of the chloride electrode was −42.05 mV as compared to −45.18 at start. The testing was stopped after running the 506 samples. The slope of potassium electrode when the testing was stopped was 58.53 mV and the slope of chloride electrode was −43.23 mV. There was practically no change from the start of the testing a year earlier. This testing clearly demonstrated the excellent performance characteristics of the solid state potassium and chloride electrodes made with the embodiment of the present invention. It also demonstrated the long shelf life of this type of electrodes even after prior usage. The electrodes made according to the present invention have long shelf life, extended linearity, minimal drift, quick stabilization and fast response times. The same performance characteristics should be applicable to any other type of electrode made using the technology of the present invention.

What is claimed is:

1. A five-part ion-selective electrode for use in clinical chemistry to measure concentration(activity) of ions, including sodium, potassium, lithium, chloride, and calcium, in blood, serum, plasma, cerebrospinal fluid, urine, fertilizer, and industrial fluids, comprising in combination:
(a) an electrode body (10);
(b) an electrode front cover (20);
(c) electrode back cover (50);
(d) a silver wire internal reference electrode (30) having an electrical connector (31) adapted to connect the electrode to a measuring instrument; and
(e) an ion-selective electrode membrane (56);
said electrode body (10) having an upper, large cavity (42) and a lower, smaller cavity (43) which together comprise deep cavity (11),
said silver wire internal reference electrode(30) positioned with the silver wire extending into said larger cavity (42) of said electrode body (10),
said electrode front cover (20) and said electrode back cover (50) affixed to said electrode body (10) to hold said reference electrode (30) and its electrical connector (31) in operating position, and said ion-selective electrode membrane (56) having been formed in situ in said deep cavity (11) to fill said cavity and electrically interface with and surround the otherwise exposed surface of the silver wire of said reference electrode (30).

2. An ion-selective electrode in accordance with claim 1 additionally having a conductive barrier membrane (54) positioned in the flow path of samples in said ion-selective electrode and said internal reference electrode (30).

3. In the production of a linear flow-through ion selective electrode, the improvement which comprises forming the ion-selective membrane in situ, in surrounding, active relation to the silver wire of the reference electrode.
